(19) United States
(12) Patent Application Publication
(10) Pub. No.: US 2025/0066931 A1
(43) Pub. Date: Feb. 27, 2025

(54) ELECTROLYSER SYSTEM AND METHOD OF USE

(71) Applicant: SUNGREENH2 PTE. LTD., Singapore (SG)

(72) Inventor: Saeid Masudy Panah, Singapore (SG)

(73) Assignee: SUNGREENH2 PTE. LTD., Singapore (SG)

(21) Appl. No.: 18/948,195

(22) Filed: Nov. 14, 2024

Related U.S. Application Data
(63) Continuation-in-part of application No. 18/781,675, filed on Jul. 23, 2024.
Application No. 18/781,675 is a continuation-in-part of application No. 18/419,529, filed on Jan. 22, 2024.
(60) Provisional application No. 63/440,690, filed on Jan. 23, 2023.
(60) Provisional application No. 63/620,078, filed on Jan. 11, 2024.

(51) Int. Cl. C25B 9/23; C25B 1/04; C25B 11/031; C25B 11/037; C25B 11/075

(52) U.S. Cl. CPC C25B 9/23; C25B 1/04; C25B 11/031; C25B 11/037; C25B 11/075

(57) ABSTRACT

An electrolyser comprising: a solid-state membrane; an ion-conductive electrolyte; a gas-electrolyte separator; and an anion exchange membrane (“AEM”). The electrolyser may be an anion exchange (“AE”), AEM, or alkaline electrolyser. An electrolyser comprising: an electrode; the electrode comprising a catalyst coating; the catalyst coating comprising micrometer-sized pores and/or a microporous internal structure. The electrode, micrometer-sized pores, and/or a microporous internal structure may be configured to increase gas release from the electrolyser. A method for manufacturing an electrode, the method comprising mixing a catalyst with a pore-forming agent to form a slurry.

### CROSS-REFERENCE TO RELATED APPLICATIONS

This application is a continuation-in-part application of U.S. patent application Ser. No. 18/781,675, entitled “ELECTROLYSER SYSTEM AND METHOD OF ELECTRODE MANUFACTURE”, filed on Jul. 23, 2024, which application is a continuation-in-part application of U.S. patent application Ser. No. 18/419,529, entitled “ELECTROLYSER SYSTEM AND METHOD OF ELECTRODE MANUFACTURE”, filed on Jan. 22, 2024, which claims priority and the benefit of U.S. Provisional Application No. 63/440,690, entitled “ELECTROLYSER SYSTEM AND METHOD OF ELECTRODE MANUFACTURE” filed on Jan. 23, 2023, and claims priority and the benefit of U.S. Provisional Application No. 63/620,078, entitled “ELECTROLYSER SYSTEM AND METHOD OF USE” filed on Jan. 11, 2024. The specification and claims of the aforesaid applications are incorporated herein by reference in their entirety.

### FIELD OF THE INVENTION

Embodiments of the present invention relate to an electrolyser system with an anion exchange membrane. Embodiments of the present invention also relate to electrode structure and fabrication methods for electrolysers.

### BACKGROUND OF THE INVENTION

Hydrogen is an important part of any discussion on sustainability and emission reduction across major energy sectors. In addition to being a feedstock and process gas for many industrial processes, hydrogen is emerging as a fuel alternative for transportation applications. Renewable sources of hydrogen are therefore required to increase in capacity. Low-temperature electrolysis of water is currently the most mature method for carbon-free hydrogen generation and is reaching relevant scales to impact the energy landscape. However, costs for the low-temperature electrolysis of water still need to be reduced to be economical with traditional sources for the production of hydrogen. Operating cost reductions are enabled by the availability of low-cost sources of renewable energy, and the potential exists for a large reduction in capital cost with material and manufacturing optimization.

Challenges concerning hydrogen production by means of electrolyser systems include electrolyser system stability and the high cost of the electrode materials. Research efforts aiming to improve the electrocatalytic activity of platinum group metals (PGM) based catalysts are underway. Other research efforts involve the reduction of the amount of PGMs loading or elimination of PGMs altogether by developing a non-PGM electrode catalyst. Anion exchange (“AE”) and anion exchange membrane (“AEM”) electrolysers require electrodes with careful design to optimize performance.

AEM electrolysers are pivotal in sustainable hydrogen production, but their efficiency is often hindered by gas trapping within the electrode structure, leading to performance loss. Existing technologies, such as optimizing flow channels, can be effective in certain contexts. However, these methods are often complex and not well-suited to address the specific challenges faced by AEM electrodes.

What is needed is an electrode structure that combines increased surface area, uniform distribution of nanostructures, heightened aspect ratio, an optimized catalyst ratio, and a gradient catalyst design, resulting in superior efficiency for an AE and/or AEM electrolyser.

What is also needed is an alternative method that simplifies electrode fabrication while achieving a high-performance, porous structure designed to optimize gas release.

### BRIEF SUMMARY OF EMBODIMENTS OF THE PRESENT INVENTION

Embodiment of the present invention relate to an electrolyser comprising: a solid-state membrane; an ion-conductive electrolyte; a gas-electrolyte separator; and an anion exchange membrane. In another embodiment, the electrolyser is an alkaline electrolyser. In another embodiment, the anion exchange membrane comprises a catalyst. In another embodiment, the catalyst comprises nickel. In another embodiment, the catalyst comprises iron. In another embodiment, the catalyst comprises nickel and iron in a ratio of 70:30 to 75:25. In another embodiment, the anion exchange membrane comprises a gradient catalyst. In another embodiment, the gradient catalyst comprises a nanostructured nickel nanoparticle body. In another embodiment, the gradient catalyst comprises a surface layer of nickel alloy.

Embodiments of the present invention also relate to an electrolyser comprising: an electrode, the electrode comprising: a catalyst coating; a sintered structure; and micrometer-sized internal pores. In another embodiment, the internal pores are configured to increase gas release from the electrolyser. In another embodiment, the electrolyser is an anion exchange membrane electrolyser. In another embodiment, the electrode is free of any alloy. In another embodiment, the pores are patterned.

Embodiment of the present invention also relate to a method of manufacturing an electrode, the method comprising: mixing a catalyst with a pore-forming agent to form a slurry; casting the slurry to form a cast slurry; sintering the cast slurry to form a sintered electrode; and leaching the sintered electrode to selectively dissolve the pore-forming material. In another embodiment, the pore-forming agent comprises aluminum. In another embodiment, the pore-forming agent comprises zinc. In another embodiment, the leaching comprises immersing the sintered electrode in a caustic solution. In another embodiment, the caustic solution comprises potassium hydroxide. In another embodiment, the caustic solution is at a molarity of 5 molar to 9 molar.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIGS. 1A and 1B are images showing of a surface of an electrode, according to an embodiment of the invention;

FIG. 2 is an image showing a cross-section of an electrode with a step distribution of catalysts, according to an embodiment of the invention;

FIG. 3 is an image showing welded electrode plates, according to an embodiment of the invention; and

FIG. 4 is an image showing a fused nanostructured catalyst, according to an embodiment of the invention.

### DETAILED DESCRIPTION OF THE INVENTION

Embodiments of the present invention relate to an electrolyser comprising: a solid-state membrane; an ion-conductive electrolyte; a gas-electrolyte separator; and an anion exchange membrane (“AEM”). The electrolyser may be an anion exchange (“AE”), AEM, or alkaline electrolyser. The AEM may comprise a catalyst. The catalyst may comprise nickel, iron, or a combination thereof. The optimized ratio of nickel (“Ni”) and iron (“Fe”) catalysts may be in a Ni/Fe ratio of about 70:30 to about 75:25. The AEM may comprise a gradient catalyst comprising a nanostructured nickel nanoparticle body fused together and a surface layer of a nickel alloy catalyst.

Embodiments of the present invention also relate to an electrolyser, the electrolyser comprising: an electrode; the electrode comprising a catalyst coating; the catalyst coating comprising micrometer-sized pores and/or a microporous internal structure. The electrode, micrometer-sized pores, and/or a microporous internal structure may be configured to increase gas release from the electrolyser. The electrolyser may be an anion exchange membrane (“AEM”) electrolyser. The electrode may be free of any alloy.

Embodiments of the present invention also relate to a method for manufacturing an electrode, the method comprising mixing a catalyst with a pore-forming agent to form a slurry. The slurry may be homogenous. The catalyst may be a powder. The pore-forming agent may include, but is not limited to, aluminum, zinc, or a combination thereof. The method may further comprise casting the slurry to form a casted slurry. The casted slurry may be sintered to form a sintered structure. The sintered structure may be subjected to a leaching process selectively dissolve the pore-forming material, leaving a stable, microporous structure. The method may comprise a non-alloying process and/or the preventing of the formation of an alloy. The microporous structure may be patterned and may be internal to the electrode.

The electrode may comprise a region gradient porosity wherein the porosity gradually increases along a dimension of the electrode, e.g., a gradient catalyst configuration. The electrode may comprise a plurality of layers, each layer having a different porosity and forming a nanostructure. The nanostructure may be uniform in its porosity. The gradient catalyst configuration may comprise a nanostructured nickel nanoparticle body fused together and a surface layer of nickel alloy catalyst.

The electrolyser system may have greater electrode efficiency and long-term stability compared to a conventional electrolyser. The electrolyser system may comprise an electrode demonstrating improved performance compared to a conventional electrode. The improved performance may be due to modifications including, but not limited to, increased surface area relative to a conventional electrode, uniform distribution of a nanostructure, a heightened aspect ratio, a gradient catalyst design, or a combination thereof.

The electrode may comprise an increased surface area relative to a conventional electrode. The increased surface area may be achieved through gradient porosity control and/or nanostructure maintenance. Gradient porosity control and/or nanostructure maintenance may be coupled with uniform distribution of nanostructures, heightened aspect ratio, an optimized catalyst ratio, a gradient catalyst design, or a combination thereof.

The electrode may comprise increased porosity where the electrode contacts or is in proximity to a bipolar plate and/or a mono-plate. The electrode may comprise network empty spaces within the electrode. The enhancement of porosity may create a pathway for efficient electrolyte movement, ensuring that ions may travel into, through, and/or throughout the electrode. The electrode prevents gas from getting trapped within the electrode. Trapped gas may hinder the flow of electrolytes and deactivate some of the catalyst, and may compromise the overall efficiency of the electrolyser system.

The electrode may create a strong and/or seamless electrical connection with a bipolar plate and/or a mono-plate. The electrode and bipolar plate and/or mono-plate may be merged, ensuring they are integrated. Integration may reduce electrical resistance. Integration may facilitate efficient electron transfer between the electrode and bipolar plate and/or mono-plate, which may improve the overall conductivity of the electrochemical system. Integration may mean that there is no spatial gap between the electrode and the bi-polar plate and/or mono-plate. Integration may be accomplished by connecting the electrode and bipolar plate and/or mono-plate with a binder and/or adhesive.

The electrode may comprise a plurality of catalysts in a ratio. The ratio may enhance the use efficiency of both catalysts and minimize any potential wastage or underuse. The enhanced efficiency may maximize or improve the conversion of electrical energy to chemical energy during the electrolysis process.

The term “metal” or “metals” is defined in the specification, claims, and drawings as a compound, mixture, or substance comprising a metal atom. The term “metal” or “metals” includes, but is not limited to, a metal hydroxide, a metal oxide, a metal salt, an elemental metal, a metal ion, a non-ionic metal, a mineral, or a combination thereof.

The terms “catalyst” or “catalytic material” shall be used interchangeably in the specification, claims, and drawings. The terms “separator” and “bipolar plate” shall be used interchangeably in the specification, claims, and drawings.

The term “leach” is defined in the specification and claims as a process used to liberate, extract, free, or remove a metal or metals from a material.

The terms “micro-porous” or “micro-structure” are defined in the specification, claims, and drawings as a material wherein at least a portion of the material comprises pores less than one millimeter in diameter.

The terms “nano-porous” or “nano-structure” are defined in the specification, claims, and drawings as a material wherein at least a portion of the material comprises pores less than one micron in diameter.

The term “platinum group metal” or “PGM” includes, but is not limited to, platinum, palladium, rhodium, ruthenium, iridium, osmium, or a combination thereof.

The electrolyser system may split water into hydrogen and oxygen or a nitrogen compound into hydrogen and nitrogen at a lower voltage compared to conventional electrolysers.

The electrolyser system may comprise an electrode. The electrode may comprise an anode or a cathode. An electrochemical potential and/or voltage may be generated between and/or by the anode and the cathode. The electrolyser system may comprise a solid-state membrane and/or a gas-electrolyte separator.

The electrode may comprise a catalyst. The catalyst may comprise nickel (“Ni”), iron (“Fe”), or a combination thereof. The electrode may comprise a plurality of catalysts in a ratio. The ratio of a first catalyst to the second catalyst may be at least about 60:40, about 60:40 to about 80:20, about 65:45 to about 75:25, or about 70:30. The ratio of catalyst may form a gradient catalyst within the electrode wherein different regions of the electrode have a different catalyst ratio. The gradient catalyst may comprise a fused nano-structured nickel nanoparticle body and a surface layer of nickel alloy catalyst.

The electrode may comprise a gradient catalyst comprising a nano-structure and/or nanoparticle body fused together. The gradient catalyst may comprise a surface layer of a metal alloy catalyst. The nano-structure and/or metal alloy catalyst may be a nickel nano-structure and nickel alloy catalyst, respectively. Each nano-structure may comprise a catalyst member and a cross-linking bridge.

The combination of the nano-structure core and the alloy catalyst surface layer may create a synergistic effect on gas evolution kinetics. The nano-structure may facilitate efficient gas evolution, while the alloy catalyst layer may further accelerate the release of evolved gases, thereby preventing their accumulation within the electrode. Gas trapping may be mitigated by the gradient catalyst. The gradual transition from the nanostructured core to the alloy catalyst layer may allow gas bubbles to be efficiently released from the electrode surface and may minimize the potential for blockages or restricted gas pathways within the electrode.

The plurality of catalysts may have a synergistic effect in catalyzing the electrochemical reactions within the electrolyser. The plurality of catalysts may promote a hydrogen evolution reaction (“HER”) and/or an oxygen evolution reaction (“OER”). Where the plurality of catalysts is two catalysts, a first catalyst may promote a HER and a second catalyst may promote an OER. Nickel may promote efficient HERs, and facilitate the generation of hydrogen ions. Simultaneously, iron may promote OERs, and facilitate release of oxygen ions.

The ratio of catalysts may improve and/or maximize the synergistic interaction between the catalysts and form a catalytically-active surface. The catalytically-active surface may promote the overall electrolysis process, enhance the kinetics of the electrochemical reactions, and improve electrolyser performance.

The catalyst ratio may contribute to the stability and durability of the electrode. The catalyst ratio may reduce or minimize degradation mechanisms associated with catalyst leaching, agglomeration, or structural changes, thereby resulting in a longer operational lifespan for the electrolyser.

The electrode may comprise greater porosity where it meets a bipolar plate or mono-plate compared to other regions of the electrode. The electrode may comprise a pore network within the electrode and more pores may exist in the electrode region that meet a bipolar plate or mono-plate compared to other regions of the electrode.

The gradient catalyst may be fabricated by depositing a finer nano-structure on top of a courser nano-structure followed sintering to form the single piece electrode with step distribution of nanostructures. The terms “finer” and “courser” may refer to the pore size or width of a nano-structure element, with a finer nano-structure comprising a smaller pore and/or a narrower nano-structure element than a courser nano-structure. The gradient catalyst may comprise a nano-structure network of smaller catalysts disposed above a main catalyst that acts as connector between the different nanostructures.

This invention provides advantages over the current technology. The electrode and/or electrolyser stack may not require alloy formation, which may simplify the overall manufacturing process and reduce production steps. The electrode and/or electrolyser stack may maintain a higher purity than other electrodes or electrolysers and may be absent of residual aluminum or zinc, which may enhance the functional purity and catalytic efficiency of the electrode. The electrode and/or electrolyser stack may comprise an adjustable pore structure. The adjustable pore size may offer flexibility to create electrodes suited for different performance requirements in electrolysers.

The electrode and/or electrolyser stack may have enhanced gas management compared to other electrodes and may comprise micrometer-sized pores that reduce gas trapping, facilitate efficient gas release, and improve overall electrolysis performance compared to other electrodes and/or electrolyser stacks. The electrode and/or electrolyser stack may have a more robust performance compared to other electrodes and/or electrolyser stacks. The electrode and/or electrolyser stack may maintain better structural integrity and durability during prolonged use compared to other electrodes and/or electrolyser stacks.

The method of making the electrode and/or electrolyser stack allows for customizable fabrication such that tailored electrode structures, adaptable for various operational demands, may be manufactured.

The method of making the electrode and/or electrolyser stack allows for increased current densities and reduced overpotentials compared to other electrodes. The patterned microporous structure allows efficient gas management, contributing to extended electrode lifespan and enhanced electrolyser efficiency compared to other electrodes and/or electrolyser stacks.

Substrates including, but not limited to, nickel, stainless steel, or titanium mesh or foam, or combination thereof, may act as a substrate for nano-structure material deposition and/or as the initial point of contact between the bipolar plate (or mono-plate) and the electrode. The substrate may comprise a thickness from at least about 0.01 millimeter (“mm”), about 0.01 mm to about 5 mm, about 0.1 mm to about 4.5 mm, about 0.5 mm to about 4 mm, about 0.1 mm to about 3.5 mm, about 0.5 mm to about 3 mm, about 1 mm to about 2.5 mm, about 1.5 mm to about 2 mm, or about 5 mm. The substrates may comprise a pore per inch (“PPI”) value at least about 20 PPI, about 20 PPI to about 200 PPI, about 50 PPI to about 180 PPI, about 70 PPI to about 160 PPI, about 90 PPI to about 140 PPI, about 110 PPI to about 120 PPI, or about 200 PPI.

The gradient electrode may comprise a plurality of catalyst layers of different dimensions. The first layer of gradient electrode may comprise a metal nano-structure with a length, width, and/or height in the range of at least about 0.0005 mm, about 0.0005 mm to about 0.5 mm, about 0.005 mm to about 0.4 mm, about 0.05 mm to about 0.3 mm, about 0.1 mm to about 0.2 mm, or about 0.5 mm. The nano-structures may be deposited onto the substrate by contacting the substrate with a catalyst by pouring or using a slurry method in the presence of isopropyl alcohol (“IPA”), deionzied water (“DI”), a binder polymer, a surfactant, or a combination thereof. The second layer of metal nano-structures may comprise a metal alloy-based nano-structure with a length, width, and/or height in the range of at least about 10 nanometers (“nm”), about 10 nm to about 10000 nm, about 50 nm to about 5000 nm, about 100 nm to about 1000 nm, or about 10000 nm. Methods for deposition include the aforementioned techniques or alternatives such as sputter deposition, chemical vapor deposition, or a combination thereof. Additionally, the integration of platinum group metal (“PGM”) materials in the second layer further enhances overall catalytic performance.

The electrode may comprise a strong and/or seamless electrical connection with a plate (e.g., a bipolar plate and/or a mono-plate). The electrode may be merged with the bipolar plate and/or mono-plate to achieve a strong and/or seamless connection and improve the electrical contact resistance. Merging may be achieved by local welding of electrodes to the plates. A weld point may be formed between the electrodes and the plate to improve physical connection and proximity. A nano-structure catalyst adhesive may also be disposed at the interface between the electrodes and plates. The nano-structure catalyst adhesive may comprise a metal nanoparticle (e.g., a nickel nanoparticle) and may be applied to the back side of the electrode to be sintered to plates. The nano-structure catalyst adhesive may be applied to a single-piece electrode plate assembly to reduce the interfacial electrical resistance.

The nano-structure catalyst adhesive may comprise a lower melting point as compared to the catalyst. A metal nanoparticle with much smaller particle size mechanically mixed with phosphate was used to reduce the melting point of nano-structure catalyst adhesive. For example, a nickel phosphate alloy further reduces melting point of the nano-structure catalyst adhesive. A binder polymer, including but not limited to, polyvinyl butyral (“PVB”) may be contacted with the metal nanoparticle to create adhesive properties.

The metal nanoparticle may be a metal nanopowder. A nanopowder comprising particle sizes predominantly below three micrometers may be mechanical mixes. Mixing may be performed with ball mills comprising nickel, stainless steel, or zirconium, or combination thereof. The ball mills may comprise dimensions in the range of 50 micrometers to a few millimeters. The ball mills may be used to comminute metal nanoparticles. Milling may reduce the diameter of the metal nanoparticles to at least about 10 nm, about 10 nm to about 500 nm, about 50 nm to about 450 nm, about 100 nm to about 400 nm, about 150 nm to about 350 nm, about 200 nm to about 300 nm, or about 500 nm.

The melting point of the metal nanopowder may be reduced compared to the first layer of the metal nano-structure because of the size disparity between the metal nanopowder and the first layer of metal nano-structure. This reduction may be attributed to the finer dimensions of the metal nanoparticles, which enhance their susceptibility to melting at lower temperatures. The metal nano-structure may be contacted with phosphate to reduce the melting point of the metal nano-structure. The resultant metal phosphate alloy formation may contribute to a further reduction in the melting point of the nickel alloy nanostructures, a crucial parameter influencing subsequent deposition processes. The percentage of phosphate may be in the range of at least about 3%, about 3% to about 5%, about 3.5% to about 4.5%, or about 5% by weight.

The agglomeration of nickel nanoparticles may be prevented by controlling the alloying time. Adjustments in the milling duration may be made to maintain the desired dispersion characteristics and avoid any detrimental effects associated with excessive agglomeration.

Agglomeration and aggregation during and before sintering challenges may be reduced by mechanically mixing different types of the particles with different nanostructures sizes and mitigating van der Waals forces through surface modification of nanostructures, respectively. Surface functionalization may be performed using a surfactant and/or a dispersing agent to balance charge of nanoparticles and optimize packing.

Ball milling and mechanical methods may affect the aspect ratio of metal nanoparticles. The ball milling technique, a mechanical method, may apply mechanical force to the metal nanoparticles to reduce size and control morphology. Ball milling and mechanical methods may be followed by hydrothermal synthesis with surfactants. The surfactants may include, but are not limited to, cetyltrimethylammonium bromide (“CTAB”) and may control the growth and alignment of metal nanoparticles. The surfactant may serve as capping agents and promote anisotropic growth, which may lead to higher aspect ratios.

The electrolyser may operate as an alkaline environment. The alkaline environment may be at a pH of at least about −1, about −1 to about 6.9, about −0.5 to about 6.5, about 0 to about 6, about 0.5 to about 5.5, about 1 to about 5, about 1.5 to about 4.5, about 2 to about 4, about 2.5 to about 3.5, about 2 to about 3, or about 6.9. The pH may prevent the saturation of a catalyst and/or mitigating the risk of catalyst deactivation.

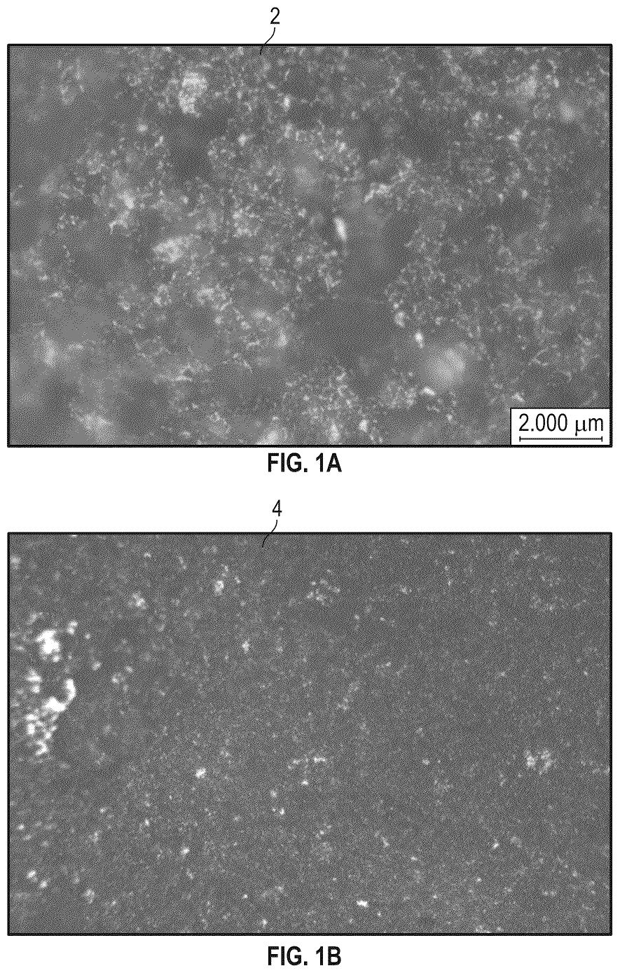

Turning now to the drawings, FIGS. 1A and 1B show interface between the electrode and plates 2 and interface between electrode and membrane 4. Interface between the electrode and plates 2 shows increased porosity between the bipolar plate (monoplate) and electrode to help the circulation of water and gas. Interface between electrode and membrane 4 shows reduced porosity at the interface between the electrode and membrane to improve the catalytic activity and ion transportation. The presence of the two different interfaces forms a step distribution of nanostructures. FIGS. 1A and 1B show the microscopic image of the surface of the electrode at the interface between the electrode and plates, and surface of the electrode at the interface between the electrode and membrane, respectively.

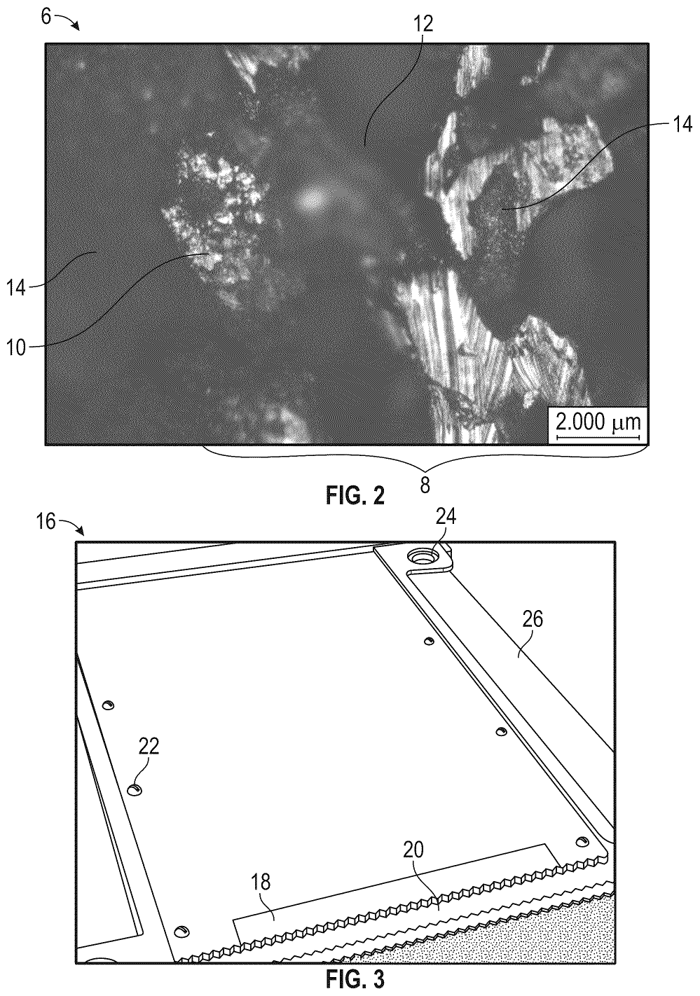

FIG. 2 shows cross section 6 of the electrodes with step distribution of the catalysts. Cross section 6 shows nanostructure 8 comprising catalysts members 10 and cross-linking bridge 12. Nanostructure 8 forms a network of pores 14.

FIG. 3 shows image 16 of locally welded electrodes 18 to plates 20. Locally welded electrodes 18 are affixed to plates 20 at welding points 22. Locally welded electrodes 18 and plates 20 are secured by housing elements 24 and 26.

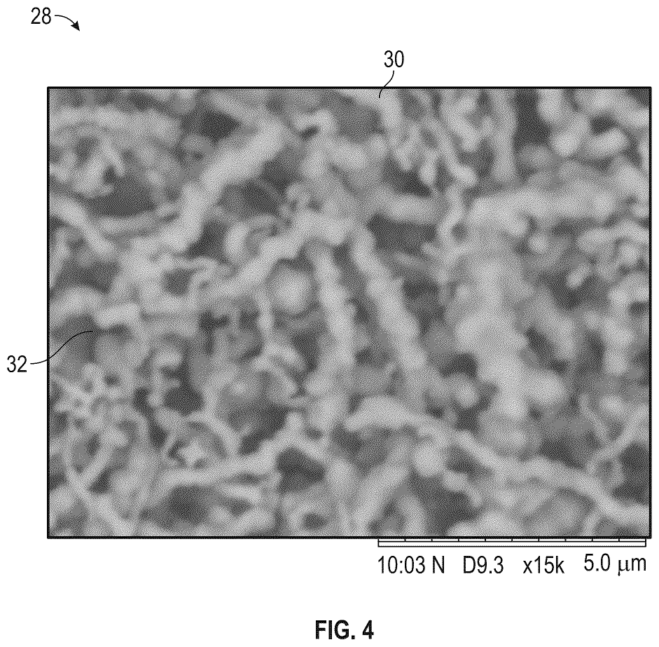

FIG. 4 shows scanning electron microscope (“SEM”) image 28. Fused nano-structures 30 interconnect into each other. The interconnection is achieved by sintering that catalyst that coats a nano-structure. Fused nano-structures 30 form a network of pores 32.

The electrolyser system may comprise at least one electrolyser stack. The electrolyser stack may comprise at least one electrolysis cell. The electrolysis cell may comprise an anode cell and/or a cathode cell. The anode and/or cathode cell may comprise a bipolar plate, a flow field plate, a gasket, an electrode, a catalyst, or a combination thereof. A membrane may be disposed between the anode cell and cathode cell. The bipolar plate may comprise an end plate, a current collector, a flow channel, or a combination thereof and may be able to facilitate the conversing of gas dissolved in solution to gas. The flow field plate may comprise a flow field.

The electrolyser system may comprise a membrane. The membrane may comprise a proton-exchange membrane (“PEM”), an anion-exchange membrane (“AEM”), an alkaline electrolyser (“AE”) stack, or a combination thereof. The PEM and/or AEM may comprise PGMs. The PEM and AEM may be an ion exchange membrane. The electrolyser system may further comprise a cation exchange membrane including, but not limited to, a perfluorosulfonic acid membrane, a polytetrafluoroethylene membrane, a chlor-alkali membrane, a carboxylic membrane, or a combination thereof. The electrolyser may achieve a high cell current density with an electrode comprising metal or mixed metal-metal oxide microstructures and/or nanostructures. The electrolyser may comprise a cathode and/or anode catalyst. The cathode and/or anode catalyst may comprise PGMs. A magnetic field may be externally applied to the electrolyser system including, but not limited to, the PEM, AEM, AE stack, electrode, catalyst, or a combination thereof. The electrolyser system may be a hydrogen electrolyser system. The membrane may allow for a mass flux of at least about 0.2 mg·cm², about 0.2 mg·cm⁻² to about 3 mg·cm⁻², about 0.4 mg·cm⁻² to about 2.5 mg·cm⁻², about 0.6 mg·cm⁻² to about 2.0 mg·cm⁻², about 0.8 mg·cm⁻² to about 1.5 mg·cm⁻², about 1.0 mg·cm⁻² to about 1.2 mg·cm⁻², or about 3 mg·cm⁻².

The electrolyser may comprise an AEM. The membrane may comprise a binder comprising an anionic, cationic, or ionomer binder, or a combination thereof. The binder may be at least partially disposed between the anode and the AEM. A binder may also be at least partially disposed between the cathode and the AEM. The AEM may comprise an anionic and/or cationic exchange membrane. The binder may improve the ionic conductivity between the AEM and the anode and/or cathode by at least about 10%, about 10% to about 40%, about 15% to about 35%, about 20% to about 30%, or about 40%. The binder may comprise an ionomer and may comprise anionic or cationic properties. The binder may be at least partially disposed between the AEM and the corresponding anode or cathode in one of the following orders:
anode, first (anionic) binder, AEM, second (anionic) binder, cathode;
anode, first (cationic) binder, AEM, second (cationic) binder, cathode;
anode, first (anionic) binder, AEM, second (cationic) binder, cathode; or
anode, first (cationic) binder, AEM, second (anionic) binder, cathode.

The membrane of the electrolyser may comprise a PEM. The PEM may comprise a current density of less than about 4 A·cm⁻², about 0.5 A·cm⁻² to about 4 A·cm⁻², about 1 A·cm⁻² to about 3.5 A·cm⁻², about 1.5 A·cm⁻² to about 3 A·cm⁻², about 2 ·cm⁻² to about 2.5 A·cm⁻², or about 4 A·cm⁻². A cationic binder may be at least partially disposed between the anode and the PEM, and/or between the cathode and the PEM. The cationic binder may comprise an ionomer and may be prepared from an ionomer solution of at least about 5%, about 5% to about 20%, about 10% to about 15%, or about 20% wt % ionomer. In conventional PEM electrolyser technology, anode and cathode catalysts comprise PGMs. Platinum is mainly used for making cathodes and iridium and ruthenium are used for making anodes. The amount of platinum group materials used by conventional PEM electrolyser technology is typically between 1 to 3 mg/cm². An electrolyser system of the present invention comprising a PEM may comprise electrodes comprising at least about 0.01 mg/cm², about 0.01 mg/cm² to about 0.1 mg/cm², about 0.02 mg/cm² to about 0.09 mg/cm², about 0.03 mg/cm² to about 0.08 mg/cm², about 0.04 mg/cm² to about 0.07 mg/cm², about 0.05 mg/cm² to about 0.06 mg/cm², about 0.1 mg/cm² PGM without sacrificing performance. The PEM may also comprise a cationic membrane and/or cationic exchange membrane.

The electrolyser system may comprise a photoelectrochemical (“PEC”) system used for water splitting. The PEC system may comprise a transparent/semi-transparent photo-anode (PA), a transparent/semi-transparent photo-cathode (PC), a solar cell (SC), or a combination thereof. The PEC system may allow the generation of green hydrogen from sunlight and water with high solar-to-hydrogen efficiency, i.e., the yield of hydrogen gas is high compared to the amount of generated hydrogen by solar panel and electrolyser without a PEC system. The PEC system may comprise non-IIIV compound materials such as conductive metal oxide and perovskite materials.

The electrolyser system may comprise a solar panel as a power source. The solar panel may be incorporated into the PEC system to directly generate green hydrogen from sunlight and water with increased solar to hydrogen (STH) efficiency.

The photoanode may comprise an n-type semiconductor and/or perovskite material including, but not limited to, BiVO₄, TiO₂, WO₃, SrTiO₃, Fe₂O₃, ZnO, or a combination thereof. The n-type semiconductor and/or perovskite material which are used to form the heterostructure with a bandgap that may be transparent. Other compatible materials may also be simultaneously deposited during the deposition of anode materials to form high performance n-type semiconductors. ZnO and Ti or ZnO, Ti, and W may be deposited simultaneously to form a high-performance mixed oxide. The photoanode may also be coated by nanoparticles of anode catalyst including, but not limited to, a PGM- or Ni-based alloy to improve the overall performance of the photoanode.

A photocathode may comprise a p-type semiconductor and/or perovskite material including, but not limited to, copper based oxides, alloys of p-type metal oxides, or a combination thereof. P-type semiconductors and/or perovskite material may form the heterostructure with a bandgap that may be transparent. The photocathode may be coated with nanoparticles of cathode catalyst including, but not limited to, a PGM- or Ni-based alloy to improve the overall performance of the photocathode.

A photoelectrode, e.g., the photoanode and/or photocathode, may be manufactured to achieve a photocurrent density of more than 14 mA·cm⁻² with a fill factor of more than 50%. A material in a photoelectrode may be optimized to achieve a crystalline structure. A crystalline structure may require the formation of a nanocrystal on the photoelectrode. The nanocrystal may be formed by tuning the deposition of material onto an electrode, for example by controlling the deposition time, deposition temperature, deposition pressure, controlling the reactant gas, or a combination thereof. The interface between the nanocrystal and electrode surface may also be optimized to integrate the nanocrystal into the photoelectrode. The interface may be optimized by controlling the deposition parameters of each material, for example by controlling the deposition time, deposition temperature, deposition pressure, controlling the reactant gas, deposition power, gas flow rate, or a combination thereof. Interfacial engineering may prevent changes in surface morphology and shape of the nanocrystal.

The photoanode and photocathode may be subsequently integrated with each other using sequential deposition. The integrated photoelectrodes may be directly integrated with a solar cell or a solar panel using physical and/or chemical deposition. Photoelectrode integration with a solar cell or panel may be performed by controlling the optical absorption of each photoelectrode or solar component so as to not interfere with the performance of the remained photoelectrode or solar component. Optical absorption may be controlled by tuning the crystal quality and thickness of materials by adjusting the deposition parameters.

The STH efficiency of PEC systems may depend on the short-circuit photocurrent density, Faradaic efficiency for hydrogen evolution, and the incident illumination power density. All these parameters have to be measured under standard solar illumination conditions (AM 1.5 G solar spectrum). The STH efficiency may be measured according to Equation 1.

$$STH = \frac{2 \times {V}_{redox} \times {I}_{WE} \times {η}_{F}}{{P}_{in}} \qquad ( 1 )$$

STH efficiency may be calculated by multiplying two times the thermodynamic potential (V_{redox}), the electrolysis current (IWE) and the Faradaic efficiency for hydrogen evolution (ηF), then dividing by the input light power (Pin).

The PEC system may use non-III-V materials, which may affect the photocurrent density and hydrogen evolution, while achieving up to 30% STH efficiency. 30% STH efficiency is about three times greater than the STH efficiency achieved with conventional PEC technology.

The electrolyser system may comprise at least one electrolysis cell at least partially disposed between a pair of electromagnetic plates. The pair of electromagnetic plates may be arranged electromagnetically perpendicular to a current flow in the stack of electrolysis cells. The electromagnetic plates may generate a quasi-homogeneous magnetic field. The electromagnetic plates may accelerate collection of the hydrogen gas. Hydrogen gas acceleration may be accomplished by the coordinated effect of the quasi-homogenous magnetic field and the current flow of a charge carrier with the electrolyser stack. The charge carrier may comprise a proton.

The electrolyser system may comprise a power source. The power source may generate an alternating current, direct current, pulsed current, or a combination thereof. The power source may generate electrical energy from renewable energy sources including, but not limited to, solar radiation, thermal energy, tidal currents, wind power, bioenergy, or a combination thereof. The power source may transmit power, e.g., electric current, to an electrolyser cell of the electrolyser system. The electrical energy may be transmitted from the power source to the electrolyser system by means of at least one wire.

The electrolyser system may be operated at a temperature of at least about 20° C., about 20° C. to about 80° C., about 30° C. to about 70° C., about 40° C. to about 60° C., about 80° C.

The electrolyser system may comprise an electrolyte. The electrolyte may comprise an alkaline electrolyte, an ion-conductive electrolyte, or a combination thereof. The electrolyte may comprise an alkali metal including, but not limited to, lithium (“Li”), sodium (“Na”), potassium (“K”), rubidium (“Rb”), cesium (“Cs”), francium (“Fr”), or a combination thereof. The electrolyte may include, but is not limited to, KOH, K₂CO₃, NaOH, or a combination thereof. The electrolyte may be at a concentration of at least about 0.1 Molar (“M”), about 0.1 M to about 10 M, about 0.5 M to about 9 M, about 1.0 M to about 8.0 M, about 2.0 M to about 7.0 M, about 3.0 M to about 6.0 M, about 4.0 M to about 5.0 M, or about 10.0 M.

The anode and the cathode may comprise a GDL and a catalyst in communication with the GDL. The catalyst may be attached to the GDL by physical or chemical deposition. The GDL may comprise a porous layer. Optionally, the anode and/or cathode may be GDLs with a catalyst coated on the surface of the anode and/or cathode. The GDL may comprise electrically conductive fiber, paper, foam, mesh, felt, or a combination thereof. The GDL may comprise a thickness of at least about 0.1 mm, about 0.1 mm to about 2 mm, about 0.2 mm to about 1.6 mm, about 0.4 mm to about 1.2 mm, about 0.6 mm to about 0.8 mm, or about 2 mm. The GDL may comprise a specific or variable porosity at least about 10%, about 10% to about 99%, about 20% to about 97%, about 30% to about 95%, about 40% to about 90%, about 50% to about 80%, about 60% to about 70%, or about 99%.

The bipolar plate may comprise a gas and/or liquid flow channel. The gas and/or liquid flow channel may comprise a channel. The channel may include, but is not limited to, a serpentine, a column-pin, or a parallel or straight channel pattern, or a combination thereof. The bipolar plate may comprise a current collector, an electrolyte pressure and flow controller, electrical resistance regulator, or a combination thereof. A bipolar plate's channel pattern and the surface engineering of deposited materials onto these plates may affect the electrolyte pressure, electrolyte flow, and/or electrical resistance of the bipolar plate. A bipolar plate's channel pattern may comprise a defined depth, width, and curvature.

A bipolar plate's channel pattern may facilitate liquid and/or gas management within an electrolysis. Optimizing the bipolar plate may prevent gas from being trapped within the electrolyser system and may result in improved electrolyte flow within the electrolyser system and gas release from the electrolyser system. Optimizing the bipolar plate may be done by changing the pattern of gas and/or liquid flow channel to prevent gas from being trapped in the bipolar plate and/or electrolyser system, and by coating the bipolar plate with conductive and/or corrosion-resistant materials to avoid the oxidation and facilitate electrical conductivity. The bipolar plate may comprise nickel, stainless steel, titanium, carbon based products, and aluminum, plastic, acrylic, foam, or a combination thereof. The conductive corrosion resistant materials may comprise an alloy including, but not limited to, gold, silver, copper, aluminum, nickel, iron, molybdenum, chromium, niobium, ruthenium, rhodium, palladium, osmium, iridium, platinum, zinc, bronze, brass, or a combination thereof.

The electrolyser system may comprise at least one electrode. The electrode may comprise an anode and/or cathode. The electrode may be thermally treated to improve performance. A vacuum thermal treatment may be applied to an electrode. The vacuum thermal treatment may be operated at a temperature of at least about 300° C., about 300° C. to about 1000° C., about 400° C. to about 900° C., about 500° C. to about 800° C., about 600° C. to about 700° C., or about 1000° C. The vacuum thermal treatment may be operated for at least about 30 min, about 30 min to about 4 hours, about 1 hour to about 3.5 hours, about 1.5 hours to about 3 hours, about 2 hours to about 2.5 hours, or about 4 hours. Thermal treatment may comprise increasing the temperature of the electrode, maintaining the temperature of the electrode, and reducing the temperature of the electrode. Increasing and decreasing the electrode temperature may be performed at a rate of at least about 5° C./min, about 5° C./min to about 20° C./min, about 10° C./min to about 15° C./min, or about 20° C./min.

The electrolyser system may comprise an anode cell and/or a cathode cell. The overall potential of the anode cell may be less than about 250 mV, about 250 mV to about 0 mV, about 225 mV to about 10 mV, about 200 mV to about 50 mV, about 150 mV to about 100 mV, or about 250 mV at a current density of about 10 mA·cm⁻². The overall potential in the cathode cell may be less than about 100 mV, about 0 mV to about 100 mV, about 5 mV to about 99 mV, about 10 mV to about 97 mV, about 15 mV to about 95 mV, about 20 mV to about 90 mV, about 30 mV to about 80 mV, about 40 mV to about 70 mV, about 50 mV to about 60 mV, or about 100 mV at current density of 10 mA·cm⁻². The cell voltage of the electrolyser system may be less than about 100 mV compared to the theoretical minimum voltage for water splitting at ambient temperature of 1230 mV.

The cathode and anode may comprise the same material composition, i.e., function as bifunctional electrodes, or comprise different material compositions, e.g. function as separate electrodes. Bifunctional electrodes may have enhanced stability compared to separate electrodes because there is no difference in electrode composition, and the risk of galvanic cell coupling and subsequent corrosion and degradation of the electrodes is reduced or avoided. A Pt electrode with the cell volage of less than 100 mV may act as a performance benchmark for both anode and cathode.

This electrode may be catalyst-coated electrode (“CCE”) that incorporates micrometer-sized pores. The micrometer-sized pores may facilitate efficient gas release and/or mitigate gas trapping.

The catalyst may nickel alloys or other catalytic materials effective in AEM electrolysis. The pore-forming agent may comprise aluminum or zinc. Aluminum and zinc may be soluble in alkaline solutions and are compatible with sintering. The leaching solution may comprise a caustic including, but not limited to, potassium hydroxide (“KOH”), sodium hydroxide (NaOH), calcium hydroxide (CaOH), or a combination thereof. The caustic may dissolve the pore-forming material without compromising the catalyst's structure. The caustic may be at a molarity of at least about 4, about 4 to about 9, about 5 to about 8, about 5 to about 7, or about 9.

The method of manufacturing the electrode may comprise forming a slurry comprising a catalyst powder and a pore-forming agents (e.g., aluminium or zinc). This slurry may be cast, sintered, and/or subjected to a leaching process in a caustic KOH solution. The caustic solution may comprise KOH. The caustic solution may have a concentration of at least about 5 molar, about 5 molar to about 8 molar, about 6 molar to about 7 molar, or about 8 molar. The caustic solution may be at a temperature of at least about 60° C., about 60° C. to about 100° C., about 65° C. to about 95° C., about 70° C. to about 90° C., about 75° C. to about 85° C., or about 100° C. The case, sintering, and/or leaching process may selectively dissolve the pore-forming material, leaving a stable, microporous structure. The method may not involve alloying the catalyst and/or the pore-forming agent and may use a simple mixture that results in a patterned, porous electrode.

The slurry may be formed my mixing a catalyst, e.g., a catalyst powder, with a pore-forming material including, but not limited to, nickel, zinc, or a combination thereof. The slurry may be homogenous. Casting the slurry may comprise at least partially disposing the slurry onto a conductive substrate and may comprise forming a uniform electrode layer to form a cast electrode. The cast electrode may be sintered. Sintering may solidify the structure while maintaining the mixed catalyst and pore-forming material. The sintered structure may be leached by at least partially immersing the electrode into a caustic solution. The caustic solution may dissolve aluminum and/or zinc and may create internal micrometer-sized pores.

The method of manufacturing the electrode may not involve alloying. The catalyst powder may be mixed with a pore-forming material (e.g., zinc or aluminum) without creating an alloy. This mixture may remain as discrete particles, which simplifies the process and avoids alloy complexity. The pore-forming agent may be selectively removed by leaching in caustic solution, leaving a network of micrometer-sized pores without integrating the agent into the catalyst at the molecular level.

The method of manufacturing the electrode may result in an electrode with almost no residual trace of the pore-forming material after leaching. This ensures higher electrode purity and better electrochemical performance.

### INDUSTRIAL APPLICABILITY

The invention is further illustrated by the following non-limiting examples.

### Example 1

An electrode was fabricated. Substrates, namely nickel, stainless steel, or titanium mesh and foam, ranging in thickness from 0.01 mm to 5 mm, served a dual role as the substrate for nanostructured material deposition and as the initial point of contact between the bipolar plate (or mono-plate) and the electrode. The substrates exhibit varied pore per inch (“PPI”) values within the range of 20-200 PPI. The first layer comprised nickel alloy-based nanostructures with dimensions spanning from 0.005 mm to 0.5 mm. Deposition involved a straightforward process of pouring the nanostructures onto the substrate or utilizing a slurry method, incorporating components such as isopropyl alcohol or deionized water, binder polymer, or surfactant. The second layer of nickel alloy-based nanostructures, with dimensions ranging from 10 nm to 10000 nm, presented a challenge due to its thin nature. Methods for deposition included the aforementioned techniques or alternatives such as sputter deposition, chemical vapor deposition, etc. Additionally, the integration of platinum group metal (PGM) materials in the second layer further enhanced overall catalytic performance.

### Example 2

A nickel nanopowder was prepared. Nickel nanopowder having particle sizes predominantly below three micrometers were employed in an experimental setup. The selection of such nano-sized particles was to ensure optimal reactivity and enhanced surface area for subsequent material processing. The nickel nanopowder underwent a mechanical mixing process utilizing ball mills. Nickel, stainless steel, or zirconium balls, each with dimensions ranging from 50 micrometers to a few millimeters, were used to comminute (mill) the nickel nanoparticles. The controlled milling operation reduced the dimensions of the nickel nanoparticles from the range of 50 micrometers to a few millimeters to the range of 10 nm to approximately 500 nm.

Given the significant size disparity between the nickel nanopowder and the first layer of nickel alloy nanostructures, the melting point of the nickel alloy nanostructures was notably reduced. This reduction was attributed to the finer dimensions of the nickel nanoparticles, which enhanced their susceptibility to melting at lower temperatures. To further manipulate the melting point of nickel, a phosphate was introduced. The resultant nickel phosphate alloy formation contributed to a further reduction in the melting point of the nickel alloy nanostructures, which was a crucial parameter influencing subsequent deposition processes. It was noteworthy that the percentage of phosphate was carefully controlled to be within the range of 3%-5% to ensure optimal alloying without compromising material integrity.

This comprehensive processing approach underscored the significance of nanopowder characteristics, mechanical mixing conditions, and phosphate alloying for achieving precise control over material properties in the fabrication of electrodes.

The preceding examples can be repeated with similar success by substituting the generically or specifically described components and/or operating conditions of embodiments of the present invention for those used in the preceding examples.

The terms, “a”, “an”, “the”, and “said” mean “one or more” unless context explicitly dictates otherwise. Note that in the specification and claims, “about” or “approximately” means within twenty percent (20%) of the amount or value given.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguring their relationships with one another.

What is claimed is:

1. An electrolyser comprising:
a solid-state membrane;
an ion-conductive electrolyte;
a gas-electrolyte separator; and
an anion exchange membrane.

2. The electrolyser of claim 1 wherein said electrolyser is an alkaline electrolyser.

3. The electrolyser of claim 1 wherein said anion exchange membrane comprises a catalyst.

4. The electrolyser of claim 3 wherein said catalyst comprises nickel.

5. The electrolyser of claim 3 wherein said catalyst comprises iron.

6. The electrolyser of claim 3 wherein said catalyst comprises nickel and iron in a ratio of 70:30 to 75:25.

7. The electrolyser of claim 1 wherein said anion exchange membrane comprises a gradient catalyst.

8. The electrolyser of claim 7 wherein said gradient catalyst comprises a nanostructured nickel nanoparticle body.

9. The electrolyser of claim 7 wherein said gradient catalyst comprises a surface layer of nickel alloy.

10. An electrolyser comprising:
an electrode, said electrode comprising:
a catalyst coating;
a sintered structure; and
micrometer-sized internal pores.

11. The electrolyser of claim 10 wherein said internal pores are configured to increase gas release from the electrolyser.

12. The electrolyser of claim 10 wherein said electrolyser is an anion exchange membrane electrolyser.

13. The electrolyser of claim 10 wherein said electrode is free of any alloy.

14. The electrolyser of claim 10 wherein said pores are patterned.

15. A method of manufacturing an electrode, the method comprising:
mixing a catalyst with a pore-forming agent to form a slurry;
casting the slurry to form a cast slurry;
sintering the cast slurry to form a sintered electrode; and
leaching the sintered electrode to selectively dissolve the pore-forming material.

16. The method of claim 15 wherein the pore-forming agent comprises aluminum.

17. The method of claim 15 wherein the pore-forming agent comprises zinc.

18. The method of claim 15 wherein leaching comprises immersing the sintered electrode in a caustic solution.

19. The method of claim 18 wherein the caustic solution comprises potassium hydroxide.

20. The method of claim 18 wherein the caustic solution is at a molarity of 5 molar to 9 molar.
